(19) United States
(12) Patent Application Publication
(10) Pub. No.: US 2006/0224712 A1
(43) Pub. Date: Oct. 5, 2006

(54) Device management in a communication system

(75) Inventor: Risto Aho, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/097,270

(22) Filed: Apr. 4, 2005

(51) Int. Cl. G06F 15/173; G06F 15/16

(52) U.S. Cl. 709/223; 709/227

(57) ABSTRACT

A method delivers device management information in a communication system. The method includes discovering an active secure connection for data communication between a communication device and a private network. The method also includes performing at least one device management task using the active secure connection. Furthermore, a virtual private network server, a device management server and a computer program product are configured to execute the method.

### FIELD OF THE INVENTION

The invention relates to communication systems, and more specifically to delivering device management information in a communication system.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device, also called a terminal, and a transceiver network element. Examples of wireless communication systems may comprise public land mobile network (PLMN), such as global system for mobile communication (GSM), the general packet radio service (GPRS) and the universal mobile telecommunications system (UMTS). Further examples of wireless communication systems may comprise wireless local area network (WLAN), wireless packet switched data networks, such as a wireless Internet Protocol (IP) network and so on.

Subscribers, such as the users or end-users, to a communication system may be offered and provided numerous services, such as calls, data communication or multimedia services or simply an access to a network. Servers may be used in provision of the services and may be operated by an operator of a network or by an external service provider. Information servers may operate in accordance with IP protocols or other packet data protocols. A transmission protocol provides transport for application layer protocols, such as a hypertext transfer protocol (HTTP). Examples of transport protocols suitable to run on top of IP may comprise a transmission control protocol (TCP), user datagram protocol (UDP) and stream control transmission protocol (SCTP).

A mobile terminal may be connected to a private network, for example to an intranet of a company. To be able to establish a virtual private network (VPN) connection to the private network, the terminal may be provided with appropriate software, such as a VPN client. The VPN client may establish a VPN tunnel, that is, a secure TCP/IP connection, to the private network using credentials, such as a password and an identifier (ID) of a user of the terminal, or other authentication and authorization means. Typically, in an enterprise environment, it is mandatory to use the VPN client for establishing a TCP/IP connection to the intranet. The VPN tunnel provides an access to information available in the private network.

It may be desired to provide also device management (DM) information from the private network. In open mobile alliance device management (OMA DM) technology, DM information may be transmitted to a terminal using a TCP/IP connection. When DM information is deliverable, a DM server typically sends a DM session initiation request or a bootstrap message, for example a short message service (SMS) message, to the terminal. Once the client in the terminal receives the DM session initiation request, the client establishes a connection to the DM server. The client may establish the connection for DM session automatically. In an alternative, the client may ask for acceptance of the DM session from a user of the terminal.

DM session might also be established through a dedicated VPN tunnel. The dedicated VPN tunnel for the DM session may be established in addition to the VPN providing access to the private network, for example, by entering the username and the password again.

However, it might be desired to be able to obtain DM information without a need to establish a separate VPN tunnel for the DM session.

It shall be appreciated that these issues are not limited to any particular communication environment, but may occur in any appropriate communication system.

### SUMMARY OF THE INVENTION

In accordance with an aspect of the invention, there is provided a method for delivering device management information in a communication system. The method comprises discovering an active secure connection for data communication between a communication device and a private network. The method also comprises performing at least one device management task for the communication device using said active secure connection.

In accordance with a further aspect of the invention, there is provided a computer program product. Said computer program product is configured to control a computing means to perform the step of discovering an active secure connection for data communication between a communication device and a private network. Said computer program product is also configured to control a computing means to perform the step of performing at least one device management task for the communication device using said secure connection.

In an embodiment, the active secure connection may comprise an active virtual private network tunnel. Said at least one device management task may be performed via a terminating end server of the virtual private network tunnel from a device management entity located in the private network.

In an embodiment, an indication about the active secure connection may be received. Said at least one device management task may be performed when there is at least one device management task to perform and the indication about active secure connection has been received.

In an embodiment, a device management session initiation request may be sent from a device management entity to the communication device when the active secure connection is discovered and when there is at least one device management task to perform. The device management session initiation request may be sent through said active secure connection. Said at least one device management task may be performed in a device management session via the active secure connection, wherein the device management session is initiated by the communication device in response to the device management session initiation request.

In an embodiment, a device management session initiation request may be sent from a device management entity to the communication device when there is at least one device management task to perform. Discovering the active secure connection may comprise becoming a party of a device management session initiated by the communication device via the active secure connection, wherein the communication device initiates said device management session, when the communication device has received the device management session initiation request and the active secure connection becomes available.

In an embodiment, performing said at least one device management comprises at least one of configuring parameters, reading parameter keys and values, setting parameter keys and values, installing software elements, upgrading software elements and uninstalling software elements.

In accordance with a further aspect of the invention, there is provided a device management entity for a communication system. The device management entity is configured to perform at least one device management task fro a communication device using an active secure connection established for data communication between the communication device and a private network.

In an embodiment, the device management entity may be further configured to perform the at least one device management task via a terminating end server of an active virtual private network tunnel in the private network. In an embodiment, the device management entity may be further configured to send a device management session initiation request to the communication device. The device management entity may be configured to send the device management session initiation request to the communication device when the active secure connection is discovered. The device management entity may be configured to send a device management session initiation request to the communication device when there is at least one device management task to perform. The device management entity may be configured to sent the management session initiation request through said active secure connection.

In an embodiment, the device management entity may further be configured to receive an indication about the active secure connection. The device management entity may be configured to perform said at least one device management task when there is at least one device management task to perform and the indication about active secure connection has been received.

In accordance with a further aspect of the invention, there is provided a virtual private network entity for a communication system. The virtual private network entity is configured to establish an active secure connection for data communication between a communication device and a private network. The virtual private network entity is also configured to act as a intermediary for enabling performing at least one device management task for the communication device via the active secure connection.

In an embodiment, the active secure connection comprises a virtual private network tunnel. In an embodiment, the virtual private network entity may be further configured to notify the device management entity about the active secure connection.

In accordance with a further aspect of the invention, there is provided a communication system. The communication system is configured to discover an active secure connection for data communication between a communication device and a private network. The communication system is also configured to perform at least one device management task for the communication device using the active secure connection.

In accordance with a further aspect of the invention, there is provided a communication system comprising a virtual private network entity in a private network for establishing an active secure connection for data communication between a communication device and the private network. The communication system further comprises a device management entity for transmitting device management information. The virtual private network server is configured to act as an intermediary for enabling performing at least one device management task for the communication device using the active secure connection.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention; and

FIG. 3 shows a signalling chart illustrating an embodiment of the invention.

### DETAILED DESCRIPTION OF PREFERRED EMBODIMENTS

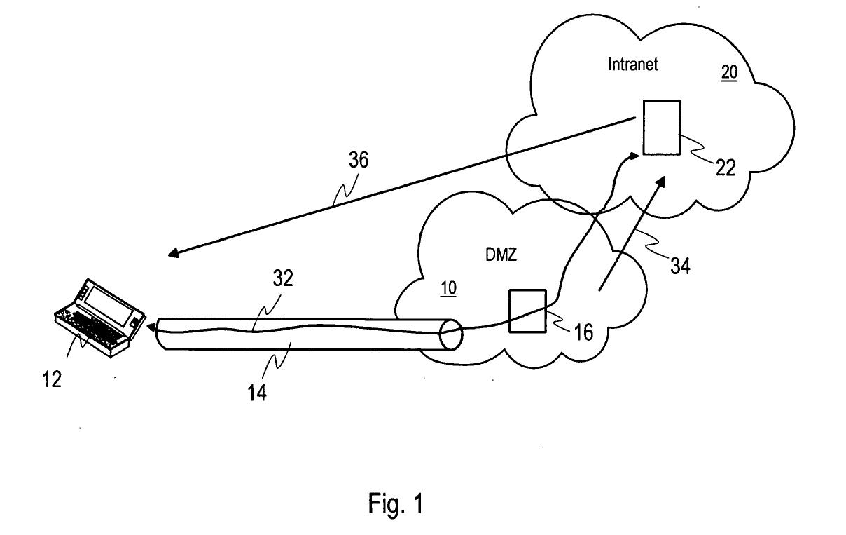

Reference is made to FIG. 1 showing an example of a network architecture in which the embodiments of the invention may be implemented. In FIG. 1, a mobile communication device 12 is arranged to access wirelessly a private network 20, such as an intranet, via a virtual private network (VPN) tunnel 14. Signalling through the VPN tunnel is illustrated by arrow line 32. A VPN server 16 is shown in a terminating end of the VPN tunnel 14 in a neutral zone 10, such as a demilitarised zone (DMZ).

The neutral zone, such as the DMZ, may provide a neutral network or area through which traffic between the private network and a public data network, such as the Internet, is directed. The neutral zone may be isolated from other zones of the communication system by means of firewalls, for example. It may be defined that only predetermined data traffic may be transmitted via the neutral zone.

When a VPN client is installed in a communication device, typically a VPN access point is configured. When an application accesses the VPN access point, a VPN tunnel, or VPN connection, starts to be established, if the VPN tunnel is not active yet, or if another VPN tunnel is required. In some implementations, a second level authentication, such as a radius authentication, may be required from a user of the communication device. The VPN client may provide a user interface (UI) that can be used to launch a VPN session without involvement of another application.

The VPN tunnel 14 may be implemented using IP security (IPsec) protocols developed by the Internet Engineering Task Force (IETF). The VPN server 16 implements the IPsec VPN functionality. In addition, the second level authentication may be provided by other network element(s).

IPsec supports secure exchange of packets between hosts and security gateways at the IP layer over potentially insecure network components. IPsec uses two protocols to provide traffic security: authentication header (AH) and encapsulating security payload (ESP). Each protocol supports two modes of use, transport mode and tunnel mode. Tunnel mode encrypts a header and a payload of each packet and provides thus more security that the transport mode, which encrypts only the payload. On a receiving side, an IPsec compliant device decrypts each packet. For encrypting and decrypting the packets, both a sending device and a receiving device share a public key. A receiver may obtain the public key and authenticate a sender using digital certificates by means of an Internet security association and key management protocol/Oakley (ISAKMP/Oakley).

A security association (SA) carries traffic by providing security services to the traffic. Security services may be provided by the use of the AH or ESP. One or more security associations may be used for a traffic stream.

In a VPN tunnel, a tunnel mode SA may be used. In a tunnel mode SA, an outer IP header specifies an IPsec processing destination and an inner IP header specifying a destination of the packet. Between the outer IP header and the inner IP header there is a security protocol header. The AH provides protection to portions of the outer IP header, all of the inner IP header and the tunnelled IP packet. The ESP provides protection only to the tunnelled IP packet.

Furthermore, a DM server 22 is shown in the private network 20. The DM server 22 may send DM session initiation requests or notifications, such as short message service (SMS) messages, to the communication device 12. Such DM session initiation requests may be used to cause the client in the communication device 12 to initiate a DM session with the DM server 22. In an alternative, the client of the communication device 12 may provide the UI that may allow a user to cause the client to initiate a DM session. Other ways of initiating a DM session may also be used, such as a timer or another indication to the client.

The DM session might be established over HTTP, WAP or another transport protocol. In embodiments of the invention, the DM session is established over a secure connection, in particular using a VPN tunnel.

In embodiments of the invention, service discovery technologies can be used to establish connections. For example, a service provider may advertise a service using service advertisement including contact information. A client running in the communication may perform a discovery, for example using multicast, for finding a service providing a desired service, such as a connection, or a connection of a certain type. An example of service discovery protocols suitable for use in embodiments of the invention may comprise, but is not limited to a service location protocol (SLP), which enables computers using the Internet to manage with little or no static configuration of network services for network based applications.

The DM session use synchronization mark-up language device management (SyncML DM) protocol for executing management commands on nodes, such as on the DM server 22 and the communication device 12. For example, the DM server 22 may reflect a set of configuration parameters for the communication device 12, such as read and set parameter keys and values. Furthermore, DM session may comprise installing, upgrading, or uninstalling software elements, or other such tasks. SyncML DM protocol consists of two parts. A setup phase comprises an alert from the DM server, if any, an authentication and device information exchange and initial management operations. A management phase comprises as many client responses and management operations as needed.

It shall be appreciated that, although only one communication device is shown in FIG. 1 for clarity, a number of communication devices may be in simultaneous communication with the communication system and may receive notifications for DM sessions and so on. A secure TCP/IP connection is shown to be established by means of the VPN tunnel. However, other secure connection means may also be used. The private network may be connected to further communication systems, such as to mobile communication networks, other wireless systems and/or fixed line communication systems. Various control entities and gateways may be included for interfacing a single communication system with one or more further communication systems.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to IPsec enabling a VPN connection or another network or transport protocol enabling a secure connection.

A communication device may be provided with an antenna or other such transceiver and receiver means for wirelessly receiving and transmitting signals from and to an access network element of the private network. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

It has now been found that an already established, active VPN tunnel might be used for a DM session without a need to enter credentials, such as the username and the password again. This might improve user experience, as the user would only need to accept the DM session establishment or the DM session could be established automatically without any user intervention.

In an embodiment, the VPN server 16 in a terminating end of the VPN tunnel 14 may inform the DM server 22 about the active VPN tunnel 14 with the terminal 12. Informing may be an indication sent from the VPN server 16 to the DM server 22 over signaling shown by arrow line 34. When the DM server 22 has DM information to be transmitted to the terminal 12, the DM server 22 may send a DM session initiation request to the terminal 12. The terminal 12 may then establish a connection to the DM server via the active VPN tunnel 14.

The DM server 22 may send DM session initiation requests to the communication device 12 through the VPN tunnel 14 over the TCP/IP signalling 32. In an embodiment, the DM server 22 may send DM session initiation requests to the communication device 12 through another signalling interface, such as over a public network, as shown by arrow line 36 in FIG. 1.

Both the embodiment, where DM session initiation requests may be sent from the DM server 22 to the communication device 12 over the signalling 32, and the embodiment, where DM session initiation requests may be sent over the signalling 36, may be implemented in the system as shown in FIG. 1. The DM server 22 may then select the embodiment, which is used for an individual DM session initiation request. For example, if the DM server 22 is aware of the active VPN tunnel 14, it may be preferable to send the DM session initiation request through the active VPN tunnel 14 over the signalling 32. On the other hand, if there is no active VPN tunnel or the DM server 22 is not aware of an active VPN tunnel, the DM session initiation request may be send over the signalling 36.

In an alternative embodiment, only one of the above embodiments, either the signalling 32 or the signalling 36, may be implemented or available for sending DM session initiation requests from the DM server 22 to the communication device 12.

In an embodiment, the DM server 22 may omit sending the DM session initiation request. The DM server 22 may start transmitting DM information to the terminal 12 directly when the VPN server 16 informs that the active VPN tunnel 14 is available.

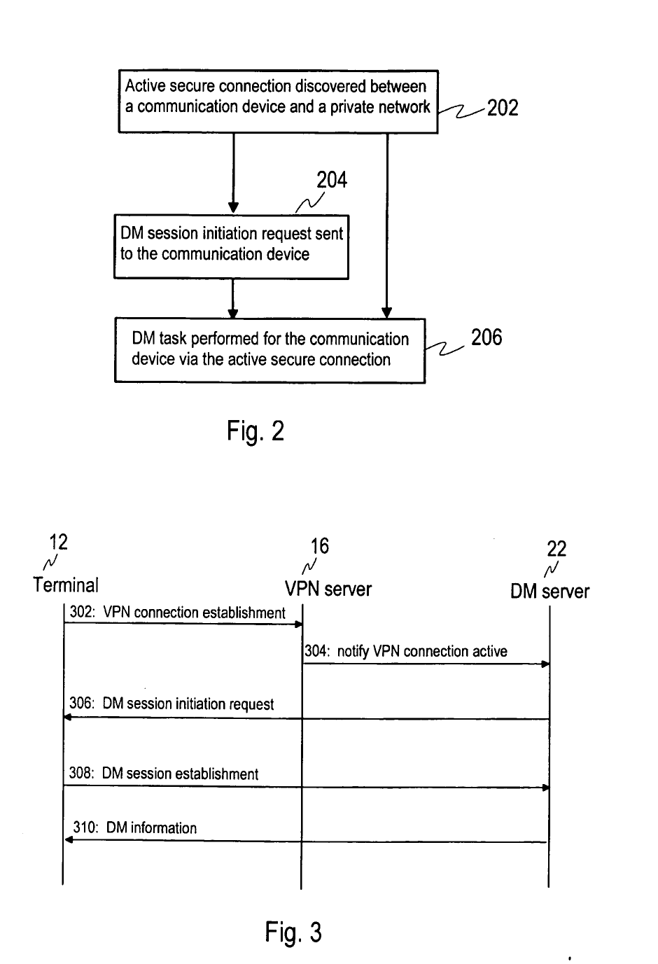

FIG. 2 shows a flow chart illustrating an embodiment of the invention. In step 202, an active secure connection, such as a VPN tunnel, between a communication device and a private network, such as an intranet, is discovered. For example, the DM server 22 may discover the active VPN tunnel when receiving respective information from the terminating end of the VPN tunnel 14.

In step 204, a DM server located in the private network may send a DM session initiation request to the communication device, when the DM server has a DM task to perform, such as DM information to transmit. In an embodiment, step 204 may be omitted. For example, the DM server 22 may start transmitting DM information to the terminal 12 directly when the DM server has a DM task to perform if the VPN server has informed that the active VPN tunnel 14 is available. When the active secure connection has been discovered, a DM session is established when there are DM tasks to perform. In other words, when there are no DM tasks to do, a DM session is preferably not established, but the DM server preferably waits until there are DM tasks to perform.

In step 206, a DM session is established between the communication device and the DM server via the active secure connection. The DM session is thus established via the VPN server 16.

FIG. 3 shows a signaling chart illustrating an embodiment of the invention. Reference is made to the exemplifying entities shown in FIG. 1. In signal 302, the terminal 12 establishes a VPN connection with the VPN server 16. In signal 304, the VPN server 16 notifies the DM server 22 about the active VPN connection. In signal 306, the DM server 22 sends a DM session initiation request to the terminal 12. As explained above, this signal may be optional. In signal 308, the terminal establishes a DM session via the VPN server 16 to the DM server 22. The DM server 22 sends DM information in signal 310 via the VPN server 16 to the terminal.

In an embodiment, the DM client in the terminal 12 may receive a DM session initiation request from the DM server 22 before there is an active secure connection available. In this embodiment, it may be advantageous to include in the DM session initiation request an indication that the secure connection was not active when the DM server sent the DM session initiation request or that the DM session initiation request was not sent in response to an activation of a secure connection. The DM client may then start to poll or listen the connections from the terminal. When the DM client finds that a secure connection, for example a secure TCP/IP connection, such as a VPN tunnel, is available, the DM client may connect to the DM server using the available secure connection.

In an embodiment, the DM client may poll all the time to find out if a secure connection is alive. In an embodiment, each time the secure connection is activated, the DM client may establish a DM session to find our whether the DM server has DM tasks to perform or not. In a further embodiment, the DM server may initialize the DM session by means of a DM session initiation request even if the DM client was polling all the time for the secure connection. In this embodiment, the DM session initiation request may be provided with an indication that the secure connection was not active when the DM server sent the DM session initiation request.

Embodiments of the invention may be performed, at least in part, by means of a computer program product embodied on a computer-readable medium, said computer program product configured to control a computing means to perform any of the steps according to embodiments.

Although the invention has been described in the context of particular embodiments, various modifications are possible without departing from the scope and spirit of the invention as defined by the appended claims. In particular, even if a virtual private network is mainly used as an exemplifying communication environment, embodiments of the invention may be implemented in another appropriate communication system providing secure connections.

1. A method for delivering device management information in a communication system, the method comprising:
discovering an active secure connection for data communication between a communication device and a private network; and
performing at least one device management task for the communication device using said active secure connection.

2. The method according to claim 1, wherein the step of discovering the active secure connection comprises discovering an active virtual private network tunnel.

3. The method according to claim 2, wherein the step of performing comprises performing said at least one device management task via a terminating end server of the virtual private network tunnel from a device management entity located in the private network.

4. The method according to claim 1, wherein the step of discovering comprises receiving an indication about the active secure connection.

5. The method according to claim 4, wherein the step of performing comprises performing said at least one device management task when there is at least one device management task to perform and the indication about active secure connection has been received.

6. The method according to claim 1, wherein the step of performing comprises sending from a device management entity a device management session initiation request to the communication device when the active secure connection is discovered and when there is at least one device management task to perform.

7. The method according to claim 6, wherein the step of performing comprises sending the device management session initiation request through said active secure connection.

8. The method according to claim 6, wherein the step of performing further comprises performing said at least one device management task in a device management session via the active secure connection, wherein the device management session is initiated by the communication device in response to the device management session initiation request.

9. The method according to claim 1, wherein the step of performing comprises sending from a device management entity a device management session initiation request to the communication device when there is at least one device management task to perform.

10. The method according to claim 9, wherein the step of discovering comprises becoming a party of a device management session initiated by the communication device via the active secure connection, wherein the communication device initiates said device management session, when the communication device has received the device management session initiation request and the active secure connection becomes available.

11. The method according to claim 1, wherein the step of performing said at least one device management comprises at least one of configuring parameters, reading parameter keys and values, setting parameter keys and values, installing software elements, upgrading software elements and uninstalling software elements.

12. A computer program product embodied on a computer-readable medium, said computer program product configured to control a computing means to perform the steps of:
discovering an active secure connection for data communication between a communication device and a private network; and
performing at least one device management task for the communication device using said secure connection.

13. A device management entity for a communication system, the device management entity configured to perform at least one device management task a communication device using an active secure connection established for data communication between the communication device and a private network.

14. The device management entity according to claim 13, further configured to perform the at least one device management task via a terminating end server of an active virtual private network tunnel in the private network.

15. The device management entity according to claim 13, further configured to send a device management session initiation request to the communication device.

16. The device management entity according to claim 15, further configured to send a device management session initiation request to the communication device when there is at least one device management task to perform.

17. The device management entity according to claim 15, further configured to send the device management session initiation request to the communication device when the active secure connection is discovered.

18. The device management entity according to claim 17, further configured to sent the management session initiation request through said active secure connection.

19. The device management entity according to claim 13, further configured to receive an indication about the active secure connection.

20. The device management entity according to claim 19, further configured to perform said at least one device management task when there is at least one device management task to perform and the indication about active secure connection has been received.

21. The device management entity according to claim 20, wherein said at least one device management task comprises at least one of configuring parameters, reading parameter keys and values, setting parameter keys and values, installing software elements, upgrading software elements and uninstalling software elements.

22. A virtual private network entity for a communication system, the virtual private network entity configured to:
establish an active secure connection for data communication between a communication device and a private network; and
act as a intermediary for enabling performing at least one device management task for the communication device via the active secure connection.

23. The virtual private network entity according to claim 22, wherein the active secure connection comprises a virtual private network tunnel.

24. The virtual private network entity according to claim 22, further configured to notify the device management entity about the active secure connection.

25. A communication system configured to:
discover an active secure connection for data communication between a communication device and a private network; and
perform at least one device management task for the communication device using the active secure connection.

26. A communication system comprising:
a virtual private network entity in a private network for establishing an active secure connection for data communication between a communication device and the private network; and
a device management entity for transmitting device management information,
wherein the virtual private network entity is configured to act as an intermediary for enabling performing at least one device management task for the communication device using the active secure connection.

27. The communication system according to claim 26, wherein the active secure connection comprises an active virtual private network tunnel.

28. The communication system according to claim 26, wherein the virtual private network entity is configured to send an indication about the active secure connection to the device management entity.

29. The communication system according to claim 28, wherein the device management entity is configured to perform said at least one device management task when there is at least one device management task to perform and the indication about active secure connection has been received.

30. The communication system according to claim 26, wherein the device management entity is configured to send a device management session initiation request to the communication device when the active secure connection is discovered and when there is at least one device management task to perform.

31. The communication system according to claim 30, wherein the device management entity device is configured to sent the management session initiation request through said active secure connection.

32. The communication system according to claim 26, wherein the device management entity is configured to send a device management session initiation request to the communication device when there is at least one device management task to perform.

33. The communication system according to claim 26, wherein said at least one device management task comprises at least one of configuring parameters, reading parameter keys and values, setting parameter keys and values, installing software elements, upgrading software elements and uninstalling software elements.
